(19) United States
(12) Patent Application Publication
(10) Pub. No.: US 2003/0134172 A1
(43) Pub. Date: Jul. 17, 2003

(54) Integrated fuel cell and electrochemical power system employing the same

(76) Inventors: Wendy C. Grande, Solana Beach, CA (US); Jeffrey A. Colborn, Cardiff-by the Sea, CA (US)

Correspondence Address: HOWREY SIMON ARNOLD & WHITE LLP, 301 RAVENSWOOD AVENUE, BOX 34, MENLO PARK,, CA, 94025, US

(21) Appl. No.: 10/044,147

(22) Filed: Jan. 11, 2002

(51) Int. Cl. H01M 8/02; H01M 8/08; H01M 8/10; H01M 12/06; B05D 5/12

(52) U.S. Cl. 429/34; 429/27; 429/30; 429/46; 427/115

(57) ABSTRACT

An electrochemical power system including one or more fuel cells integrated on or into a substrate is described. For each fuel cell, at least two stacked layers comprising a cathode layer and an ion exchange layer are situated within the substrate. A first access path for allowing an oxidant to access the cathode layer is provided from one side of the substrate, and a second access path for allowing a fuel or a reaction medium containing a fuel to access a layer in the stack is provided from the other side of the substrate. A third access path, which may be the same or different from the second access path, allows egress of one or more reaction products from the layer. A first conductor connects to the cathode, and a second conductor connects to the second access path or the layer in the stack accessible through the second access path. A regeneration unit for regenerating fuel from one or more reaction products also can be integrated on or into the substrate. The regeneration unit comprises a reaction chamber with one or more areas of ingress and one or more areas of egress. A first flow path interconnects the one or more areas of egress of the reaction chamber with the second access path of the one or more fuel cells. A second flow path interconnects the third access path of the one or more fuel cells with the one or more areas of ingress of the reaction chamber.

### FIELD OF THE INVENTION

This invention relates generally to fuel cells, and, more specifically, to fuel cells and electrochemical power systems employing fuel cells which are integrated on or into a substrate such as a semiconductor substrate.

### RELATED ART

Integrated circuits (ICs) today fulfill diverse applications and uses, ranging from incorporation into medical devices for implantation or insertion into the human body, use in credit cards, use in conjunction with merchandise for tracking purposes, and use in miniature consumer electronics.

Traditionally, ICs are powered by batteries such as button cells. However, button cells, despite their small size, still cannot easily fit onto integrated circuits. Moreover, button cells must be replaced after discharge, and are therefore of limited effectiveness.

Fuel cells can be attractive alternatives to traditional energy sources such as batteries because they can be refueled after discharge with fuel regenerated from the reaction products produced during discharge. However, fuel cells, like button cells, are difficult to fit onto integrated circuits, particularly in conjunction with related components, such as fuel reservoirs or cartridges.

### SUMMARY

In one aspect, the invention provides a fuel cell integrated on or into a unitary planar substrate having first and second sides. At least two stacked layers comprising a cathode layer and an ion exchange layer are situated within the substrate, with the ion exchange layer being oriented substantially within the plane of the substrate. A first access path for allowing an oxidant to access the cathode layer from the first side of the substrate is provided. A second access path for allowing a fuel or a reaction medium containing a fuel to access a layer in the stack from the second side of the substrate is also provided. A first conductor connects to the cathode, and a second conductor connects to the second access path or the layer in the stack accessible through the second access path.

In another aspect, the invention provides an electrochemical power system employing one or more fuel cells integrated on or into a substrate having first and second sides. Each such fuel cell comprises at least two stacked layers comprising a cathode layer and an ion exchange layer situated within the substrate. A first access path for allowing an oxidant to access the cathode layer is provided from one side of the substrate, and a second access path for allowing a fuel or a reaction medium containing a fuel to access a layer in the stack is provided from the other side of the substrate. A third access path, which may be the same or different from the second access path, is provided for allowing egress of one or more reaction products from the layer. A first conductor connects to the cathode, and a second conductor connects to the second access path or the layer in the stack accessible through the second access path.

The system also can comprise a regeneration unit integrated on or into the substrate. The regeneration unit, in turn, comprises a reaction chamber integrated on or into the substrate which is capable of holding one or more reaction products, the chamber having an interior and one or more regions of ingress and one or more regions of egress. An anode connects to the interior of the reaction chamber, and a cathode connects to the interior of the reaction chamber. A first flow path, optionally integrated on or into the substrate, interconnects the one or more third access paths of the one or more fuel cells with the one or more regions of ingress of the reaction chamber. A second flow path, optionally integrated on or into the substrate, interconnects the one or more regions of egress of the reaction chamber with the one or more second access paths of the one or more fuel cells.

A further aspect of the invention comprises a metal fuel cell integrated on or into a substrate having first and second sides. This fuel cell comprises at least two stacked layers comprising a cathode layer and an ion exchange layer situated within the substrate. A first access path allows an oxidant to access the cathode layer from one side of the substrate. A second access path allows a reaction medium containing a metal fuel to access the ion exchange layer in the stack from the other side of the substrate. A first conductor connects to the cathode, and a second conductor connects to the second access path.

An additional aspect of the invention comprises a method of integrating a fuel cell on or into a substrate. This method may involve the use of subtractive processes such as etching or patterned etching. The method begins by placing at least two stacked layers comprising a cathode layer and an ion exchange layer on a surface of a substrate. Then, an access path to one of the layers that extends inward from an opposing surface of the substrate is formed. A first conductor is connected to the cathode layer, and a second conductor is connected to the access path or the layer that is made accessible by the access path.

Another aspect of the invention comprises a method of integrating a regeneration unit on or into a substrate. The method begins by forming a cavity that extends inward from a surface of the substrate, the cavity having an interior and one or more regions of ingress and egress thereto. Next, a first electrode is connected to the interior of the cavity, and a second electrode is connected to the interior of the cavity.

A further aspect of the invention comprises a method of integrating a fuel cell on or into a substrate. This method may involve the use of additive processes such as injection molding. The method begins by forming an electrode assembly comprising one or more electrode elements, with each of the electrode elements in the assembly having at least two stacked layers comprising a cathode layer and an ion exchange layer. Next, the method proceeds to forming a substrate around the electrode assembly, with first and second conductors connecting a surface of the substrate to the electrode assembly, a first access path for an oxidant to the ion exchange layer in each of the electrode assemblies, and a second opposing access path for fuel or a reaction medium containing a fuel to one of the layers in the stack.

An additional aspect comprises any combination of the foregoing aspects.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a simplified block diagram of an electrochemical power source system.

FIG. 2 is a simplified block diagram of an alternate embodiment of an electrochemical power source system.

FIG. 3 is a side view of an embodiment of a fuel cell integrated on or into a substrate.

FIG. 4 is a top view of an embodiment of a fuel cell integrated on or into a substrate.

FIG. 5 is a top view of an embodiment of an electrochemical power system integrated on or into a substrate.

FIG. 6A is a side view of the fuel cell portion of an embodiment of an electrochemical power system integrated on or into a substrate.

FIG. 6B illustrates a permissible orientation of an ion exchange membrane in the embodiment of FIGS. 5 and 6A.

FIG. 7 is a side view of the regeneration unit of an embodiment of an electrochemical power system integrated on or into a substrate.

FIG. 8 is a side view of a reservoir in an embodiment of an electrochemical power system integrated on or into a substrate.

FIG. 9A is a side view of a second embodiment of the fuel cell portion of an electrochemical power system integrated on or into a substrate.

FIG. 9B is a side view of a cathodic element employed in the system of FIG. 9A.

FIG. 10 is a top view of a second embodiment of an electrochemical power system integrated on or into a substrate.

FIG. 11 is a side view of a third embodiment of the fuel cell portion of an electrochemical power system integrated on or into a substrate.

FIG. 12 is a top view of a third embodiment of an electrochemical power system integrated on or into a substrate.

FIG. 13 is a flowchart of a first embodiment of a method of integrating a fuel cell on or into a substrate.

FIGS. 14A-14I illustrate the steps comprising one example of a method of integrating a fuel cell on or into a substrate.

FIGS. 15A-15G illustrate the steps comprising a second example of a method of integrating a fuel cell on or into a substrate.

FIG. 16 is a flowchart of an embodiment of a method of integrating a regeneration unit on or into a substrate.

FIG. 17 is a side view of a regeneration unit in a second embodiment of an electrochemical power system integrated on or into a substrate.

FIG. 18 is a flowchart of a second embodiment of a method of integrating a fuel cell on or into a substrate.

### DETAILED DESCRIPTION

Introduction to Fuel Cells and Electrochemical Power Systems Employing Fuel Cells

A hydrogen fuel cell is a fuel cell that uses hydrogen as a fuel. A metal fuel cell is a fuel cell that uses a metal, such as zinc particles, as fuel. In a metal fuel cell, the fuel is generally stored, transmitted and used in the presence of a reaction medium, such as potassium hydroxide solution.

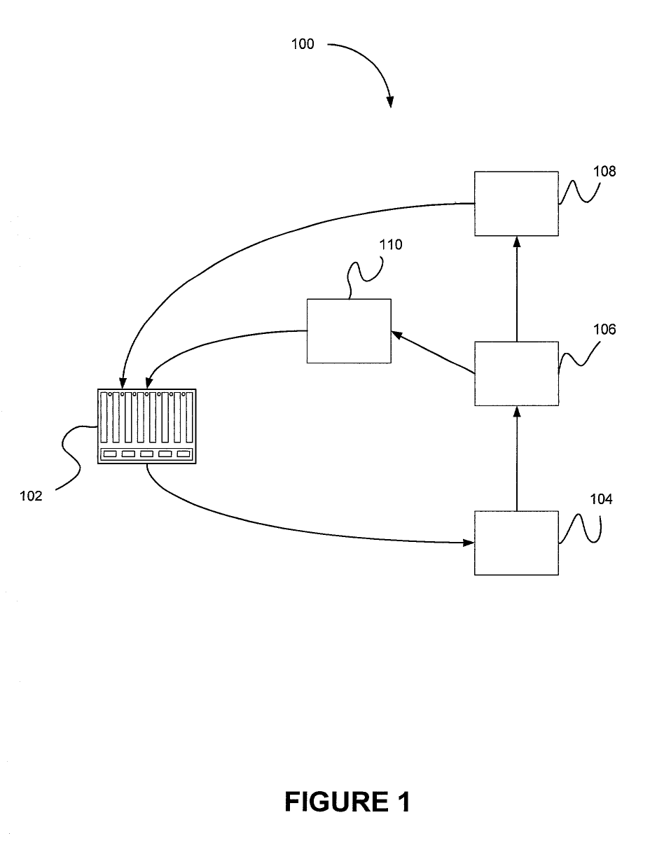

A block diagram of a fuel cell is illustrated in FIG. 1. As illustrated, the fuel cell comprises a power source 102, an optional reaction product storage unit 104, an optional regeneration unit 106, a fuel storage unit 108, and an optional second reactant storage unit 110. The power source 102 in turn comprises one or more cells each having a cell body defining a cell cavity, with an anode and cathode situated in each cell cavity. The cells can be coupled in parallel or series, or independently coupled to different electrical loads. In one implementation, they are coupled in series.

The anodes within the cell cavities in power source 102 comprise the fuel stored in fuel storage unit 108 or an electrode. Within the cell cavities of power source 102, an electrochemical reaction takes place whereby the anode releases electrons, and forms one or more reaction products. Through this process, the anodes are gradually consumed.

The released electrons flow through a load to the cathode, where they react with one or more second reactants from an optional second reactant storage unit 110 or from some other source. This flow of electrons through the load gives rise to an over-potential (i.e., work) required to drive the demanded current, which over-potential acts to decrease the theoretical voltage between the anode and the cathode. This theoretical voltage arises due to the difference in electrochemical potential between the anode (for example, in the case of a zinc fuel cell, Zn potential of −1.215V versus SHE (standard hydrogen electrode) reference at open circuit) and cathode (O₂ potential of +0.401V versus SHE reference at open circuit). When the cells are combined in series, the sum of the voltages for the cells forms the output of the power source.

The one or more reaction products can then be provided to optional reaction product storage unit 104 or to some other destination. The one or more reaction products, from unit 104 or some other source, can then be provided to optional regeneration unit 106, which regenerates fuel and/or one or more of the second reactants from the one or more reaction products. The regenerated fuel can then be provided to fuel storage unit 108, and/or the regenerated one or more second reactants can then be provided to optional second reactant storage unit 110 or to some other destination. As an alternative to regenerating the fuel from the reaction product using the optional regeneration unit 106, the fuel can be inserted into the system from an external source and the reaction product can be withdrawn from the system.

The optional reaction product storage unit 104 comprises a unit that can store the reaction product. Exemplary reaction product storage units include without limitation one or more tanks, one or more sponges, one or more containers, one or more vats, canister, chambers, cylinders, cavities, one or more barrels, one or more vessels, and the like, including those found in or which may be formed in a substrate, and suitable combinations of any two or more thereof. Optionally, the optional reaction product storage unit 104 is detachably attached to the system.

The optional regeneration unit 106 comprises a unit that can electrolyze the reaction product(s) back into fuel (e.g., hydrogen, metal particles and/or metal-coated particles, and the like) and/or second reactant (e.g., air, oxygen, hydrogen peroxide, other oxidizing agents, and the like, and suitable combinations of any two or more thereof). Exemplary regeneration units include without limitation water electrolyzers (which regenerate an exemplary second reactant (oxygen) and/or fuel (hydrogen) by electrolyzing water), metal (e.g., zinc) electrolyzers (which regenerate a fuel (e.g., zinc) and a second reactant (e.g., oxygen) by electrolyzing a reaction product (e.g., zinc oxide (ZnO)), and the like. Exemplary metal electrolyzers include without limitation fluidized bed electrolyzers, spouted bed electrolyzers, and the like, and suitable combinations of two or more thereof. The power source 102 can optionally function as the optional regeneration unit 106 by operating in reverse, thereby foregoing the need for a regeneration unit 106 separate from the power source 102. Optionally, the optional regeneration unit 106 is detachably attached to the system.

The fuel storage unit 108 comprises a unit that can store the fuel (e.g., for metal fuel cells, metal (or metal-coated) particles or liquid born metal (or metal-coated) particles or suitable combinations thereof, for hydrogen fuel cells, hydrogen or hydrogen containing compounds that can be reformed into a usable fuel prior to consumption; for alcohol fuel cells, alcohol or alcohol-containing compounds. Exemplary fuel storage units include without limitation one or more tanks (for example, without limitation, a high-pressure tank for gaseous fuel (e.g., hydrogen gas), a cryogenic tank for liquid fuel which is a gas at operating temperature (e.g., room temperature) (e.g., liquid hydrogen), a metal-hydride-filled tank for holding hydrogen, a carbon-nanotube-filled tank for storing hydrogen, a non-reactive material, e.g., stainless steel, plastic, or the like, tank for holding potassium hydroxide (KOH) and metal (e.g., zinc (Zn), other metals, and the like) particles, a tank for liquid fuel, e.g., alchohol and the like, one or more sponges, one or more containers (e.g., a plastic container for holding dry metal (e.g., zinc (Zn), other metals, and the like) particles, and the like), one or more vats, one or more barrels, one or more vessels, and the like, and suitable combinations of any two or more thereof. The fuel storage unit may be formed in a substrate. Optionally, the fuel storage unit 108 is detachably attached to the system.

The optional second reactant storage unit 110 comprises a unit that can store the second reactant. Exemplary second reactant storage units include without limitation one or more tanks (for example, without limitation, a high-pressure tank for gaseous second reactant (e.g., oxygen gas), a cryogenic tank for liquid second reactant (e.g., liquid oxygen) which is a gas at operating temperature (e.g., room temperature), a tank for a second reactant which is a liquid or solid at operating temperature (e.g., room temperature), and the like), one or more sponges, one or more containers, one or more vats, one or more barrels, one or more vessels, and the like, and suitable combinations of any two or more thereof. The second reactant storage unit may be formed in a substrate. Optionally, the optional second reactant storage unit 110 is detachably attached to the system.

In one embodiment, the fuel cell utilized in the practice of the invention system is a metal fuel cell. The fuel of a metal fuel cell is a metal that can be in a form to facilitate entry into the cell cavities of the power source 102. For example, the fuel can be in the form of metal (or metal-coated) particles or liquid born metal (or metal-coated) particles or suitable combinations thereof. Exemplary metals for the metal (or metal-coated) particles include without limitation zinc, aluminum, lithium, magnesium, iron, and the like.

In this embodiment, when the fuel is optionally already present in the anode of the cell cavities in power source 102 prior to activating the fuel cell, the fuel cell is pre-charged, and can start-up significantly faster than when there is no fuel in the cell cavities and/or can run for a time in the range(s) from about 0.001 minutes to about 1000 minutes without additional fuel being moved into the cell cavities. The amount of time which the fuel cell can run on a pre-charge of fuel within the cell cavities can vary with, among other factors, the pressurization of the fuel within the cell cavities, and the power drawn from the fuel cell, and alternative embodiments of this aspect of the invention permit such amount of time to be in the range(s) from about 1 second to about 1000 minutes or more, and in the range(s) from about 30 seconds to about 1000 minutes or more.

Moreover, the second reactant optionally can be present in the fuel cell and pre-pressurized to any pressure in the range(s) from about 0 psi gauge pressure to about 200 psi gauge pressure. Furthermore, in this embodiment, one optional aspect provides that the volumes of one or both of the fuel storage unit 108 and the optional second reactant storage unit 110 can be independently changed as required to independently vary the energy of the system from its power, in view of the requirements of the system. Suitable such volumes can be calculated by utilizing, among other factors, the energy density of the system, the energy requirements of the one or more loads of the system, and the time requirements for the one or more loads of the system. In one embodiment, these volumes can vary in the range(s) from about 10⁻¹² liters to about 1,000,000 liters. In another embodiment, the volumes can range from 10⁻¹² liters to 10 liters.

In one aspect of this embodiment, at least one of, and optionally all of, the metal fuel cell(s) is a zinc fuel cell in which the fuel is in the form of fluid borne zinc particles immersed in a potassium hydroxide (KOH) electrolytic reaction solution, and the anodes within the cell cavities are particulate anodes formed of the zinc particles. In this embodiment, the reaction products can be the zincate ion, Zn(OH)₄²⁻, or zinc oxide, ZnO, and the one or more second reactants can be an oxidant (for example, oxygen (taken alone, or in any organic or aqueous (e.g., water-containing) fluid (for example and without limitation, liquid or gas (e.g., air)), hydrogen peroxide, and the like, and suitable combinations of any two or more thereof). When the second reactant is oxygen, the oxygen can be provided from the ambient air (in which case the optional second reactant storage unit 110 can be excluded), or from the second reactant storage unit 110. Similarly, when the second reactant is oxygen in water, the water can be provided from the second reactant storage unit 110, or from some other source, e.g., tap water (in which case the optional second reactant storage unit 110 can be excluded). In order to replenish the cathode, to deliver second reactant(s) to the cathodic area, and to facilitate ion exchange between the anodes and cathodes, a flow of the second reactant(s) can be maintained through a portion of the cells. This flow optionally can be maintained through one or more pumps (not shown in FIG. 1), blowers or the like, or through some other means. If the second reactant is air, it may optionally be pre-processed to remove CO₂ by, for example, passing the air through soda lime. This is generally known to improve performance of the fuel cell.

In this embodiment, the particulate fuel of the anodes is gradually consumed through electrochemical dissolution. In order to replenish the anodes, to deliver KOH to the anodes, and to facilitate ion exchange between the anodes and cathodes, a recirculating flow of the fluid borne zinc particles can be maintained through the cell cavities. This flow can be maintained through one or more pumps (not shown), convection, flow from a pressurized source, or through some other means. As the potassium hydroxide contacts the zinc anodes, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O -> 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O -> {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (4)

In this case, the overall reaction which occurs in the cell cavities is the combination of the three reactions (1), (2), and (4). This overall reaction can be expressed as follows:

$$Zn + \frac{1}{2} {O}_{2} -> ZnO \qquad ( 5 )$$

Under real world conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction product Zn(OH)₄²⁻, and also possibly ZnO, can be provided to reaction product storage unit 104. Optional regeneration unit 106 can then reprocess these reaction products to yield oxygen, which can be released to the ambient air or stored in second reactant storage unit 110, and zinc particles, which are provided to fuel storage unit 108. In addition, the optional regeneration unit 106 can yield water, which can be discharged through a drain or stored in second reactant storage unit 110 or fuel storage unit 108. It can also regenerate hydroxide, OH⁻, which can be discharged or combined with potassium ions to yield the potassium hydroxide reaction solution.

The regeneration of the zincate ion, Zn(OH)₄²⁻, into zinc, and one or more second reactants can occur according to the following overall reaction:

$${Zn ( OH )}_{4}^{2 -} -> Zn + 2 {OH}^{-} + {H}_{2} O + \frac{1}{2} {O}_{2} \qquad ( 6 )$$

The regeneration of zinc oxide, ZnO, into zinc, and one or more second reactants can occur according to the following overall reaction:

$$ZnO -> Zn + \frac{1}{2} {O}_{2} \qquad ( 7 )$$

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, and the like are possible, as are metal fuel cells where the fuel is not in particulate form but in another form such as sheets or ribbons or strings or slabs or plates. Embodiments are also possible in which the fuel is not fluid borne or continuously re-circulated through the cell cavities (e.g., porous plates of fuel, ribbons of fuel being cycled past a reaction zone, and the like). It is also possible to avoid an electrolytic reaction solution altogether or at least employ reaction solutions besides potassium hydroxide, for example, without limitation, sodium hydroxide, inorganic alkalis, alkali or alkaline earth metal hydroxides or aqueous salts such as sodium chloride. See, for example, U.S. Pat. No. 5,958,210, the entire contents of which are incorporated herein by this reference. It is also possible to employ metal fuel cells that output AC power rather than DC power using an inverter, a voltage converter, and the like.

In a second embodiment of a fuel cell useful in the practice of the invention system, the fuel used in the electrochemical reaction that occurs within the cells is hydrogen, the second reactant is oxygen, and the reaction product is water. In one aspect, the hydrogen fuel is maintained in the fuel storage unit 108, but the second reactant storage unit 110 can be omitted and the oxygen used in the electrochemical reaction within the cells can be taken from the ambient air. In another aspect, the hydrogen fuel is maintained in the fuel storage unit 108, and the oxygen is maintained in the second reactant storage unit 110. In addition, the optional reaction product storage unit 104 can be included or omitted, and the water resulting from discharge of the unit simply discarded or stored in the reaction product storage unit 104 (if present), respectively. Later, the optional regeneration unit 106 can regenerate water from another source, such as tap water or distilled water, or from the reaction product storage unit 104 (if present) into hydrogen and oxygen. The hydrogen can then be stored in fuel storage unit 104, and the oxygen simply released into the ambient air or maintained in the second reactant storage unit 110.

In a third embodiment of a fuel cell useful in the practice of the invention system, a metal fuel cell system is provided. Such system is characterized in that it has one, or any suitable combination of two or more, of the following properties: the system optionally can be configured to not utilize or produce significant quantities of flammable fuel or product, respectively; the system can provide primary and/or auxiliary/backup power to the one or more loads for an amount of time limited only by the amount of fuel present (e.g., in the range(s) from about 0.01 hours to about 10,000 hours or more, and in the range(s) from about 0.5 hours to about 650 hours, or more); the system optionally can be configured to have an energy density in the range(s) from about 35 Watt-hours per kilogram of combined fuel and electrolyte (reaction medium) added to about 400 Watt-hours per kilogram of combined fuel and electrolyte added; the system optionally can further comprise an energy requirement and can be configured such that the combined volume of fuel and electrolyte added to the system is in the range(s) from about 0.0028 L per Watt-hour of the system's energy requirement to about 0.025 L per Watt-hour of the system's energy requirement, and this energy requirement can be calculated in view of, among other factors, the energy requirement(s) of the one or more load(s) comprising the system (In one embodiment, the energy requirement of the system can be in the range(s) from 50 Watt-hours to about 500,000 Watt-hours, whereas in another embodiment, the energy requirement of the system can be in the range(s) from 5 Watt-hours to about 50,000,000 Watt-hours; in yet another embodiment, the energy requirement can range from 5×10⁻¹² Watt-hours to 50,000 Watt-hours); the system optionally can be configured to have a fuel storage unit that can store fuel at an internal pressure in the range(s) from about −5 pounds per square inch (psi) gauge pressure to about 200 psi gauge pressure.

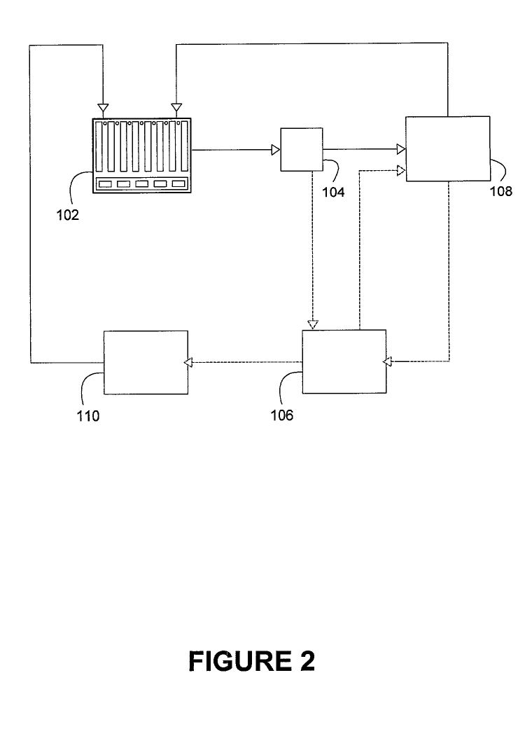

FIG. 2 is a block diagram of an alternative embodiment of a metal-based fuel cell in which, compared to FIG. 1, like elements are referenced with like identifying numerals. Dashed lines are flow paths for the recirculating reaction solution when the optional regeneration unit is present and running. Solid lines are flow paths for the recirculating anode fluid when the fuel cell system is running in idle or discharge mode. As illustrated, in this embodiment, when the system is operating in the discharge mode, optional regeneration unit 106 need not be in the flow path represented by the solid lines.

An advantage of fuel cells relative to traditional power sources such as lead acid batteries is that they can provide longer term primary and/or auxiliary/backup power more efficiently and compactly. This advantage stems from the ability to continuously refuel the fuel cells using fuel stored with the fuel cell, from some other source, and/or regenerated from reaction products by the optional regeneration unit 106. In the case of the zinc or hydrogen fuel cell, for example, the duration of time over which energy can be provided is limited only by the amount of fuel and reaction medium (if used) which is initially provided in the fuel storage unit, which is fed into the system during replacement of a fuel storage unit 108, and/or which can be regenerated from the reaction products that are produced. Thus, the system, comprising at least one fuel cell that comprises an optional regeneration unit 106 and/or a replaceable fuel storage unit 108, can provide primary and/or auxiliary/backup power to the one or more loads for a time in the range(s) from about 0.01 hours to about 10000 hours, or even more. In one aspect of this embodiment, the system can provide back-up power to the one or more loads for a time in the range(s) from about 0.5 hours to about 650 hours, or even more.

Moreover, a system in accordance with the invention optionally can be configured to expel substantially no reaction product(s) outside of the system (e.g., into the environment).

Embodiments of the Invention

As utilized herein, the term “electrode” is a conductor at the surface of, or within, which a change occurs from conduction by electrons to conduction by ions or colloidal ions; the term “cathode” is an electrode at which positive ions are discharged, or negative ions are formed, or at which other reducing reactions occur; and the term “anode” is an electrode at which negative ions are discharged, or positive ions are formed, or at which other oxidizing reactions occur. In one implementation, the electrode can comprise conductive and non-conductive regions whereby the characteristics of such regions include without limitation hydrophilic and hydrophobic domains, as applicable.

As utilized herein, a “unitary” substrate is an indivisible substrate for holding substantially all elements of a fuel cell, and includes substrates to which other elements or pieces of substrate are adhered for incidental purposes (such as a cap or lid for capping an anode cavity).

As utilized herein, terms such as “about” and “substantially” are intended to allow some leeway in mathematical exactness to account for tolerances that are acceptable in the trade, e.g., any deviation upward or downward from the value modified by “about” or “substantially” by any value in the range(s) from 1% to 20% of such value.

As employed herein, the terms or phrases “in the range(s)” or “between” comprises the range defined by the values listed after the term “in the range(s)” or “between”, as well as any and all subranges contained within such range, where each such subrange is defined as having as a first endpoint any value in such range, and as a second endpoint any value in such range that is greater than the first endpoint and that is in such range.

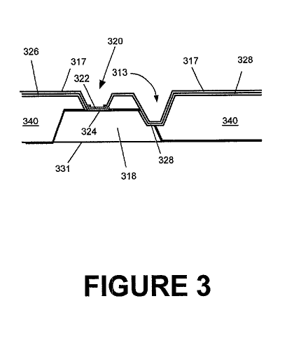

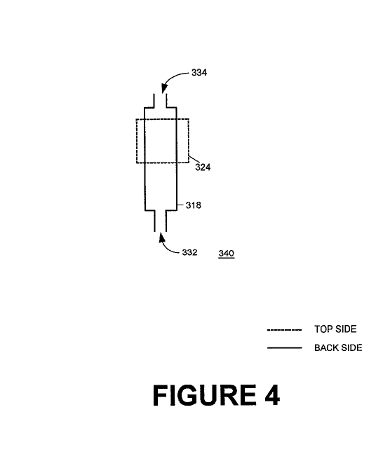

Referring to FIG. 3, a first embodiment of the invention comprises a fuel cell integrated on or into a unitary planar substrate 340. In one example, the planar substrate 340 is a semiconductor substrate in which cavities or wells are formed through subtractive processes such as etching or patterned etching. Control or load circuitry may also be integrated on the same substrate. The fuel cell comprises an anode cavity 318 integrated on or into the substrate 340 that is capable of holding a fuel. When the fuel cell is in operation, in the case of a metal fuel cell, the fuel in the cavity may form at least a portion of the anode of the fuel cell. Referring to FIG. 4, the cavity 318 has one or more regions of ingress and egress, identified with numerals 332 and 334 respectively, for the fuel and reaction products.

Referring back to FIG. 3, an optional cathode well 320 extends into a surface of the planar substrate 340 and is in general proximity to the anode cavity 318. A cathode 322 is situated in the cathode well, and ion exchange layer 324 forms at least a portion of the interior of the anode cavity 318 and separates the cathode 322 from the interior of the anode cavity 318. Referring to FIG. 4, the ion exchange layer 324 is oriented substantially within the plane of the substrate 340. (In contrast to being oriented perpendicular to or substantially perpendicular to the plane of the substrate 340). The ion exchange layer 324 substantially conducts ions but does not substantially conduct electrons. In one example, the fuel cell comprises a metal fuel cell, and the ion exchange layer 324 comprises a porous membrane composed of a polymer such as polypropylene. In another example, the fuel cell comprises a hydrogen fuel cell in which the ion exchange layer 324 comprises a proton exchange membrane composed of a cation exchange polymer. Referring back to FIG. 3, the cavity 318 may be capped by a cap 331 formed of the same or different material as the substrate 340. A first conductor 326 connects to the cathode, and a second conductor 328 connects to the interior of the anode cavity 318.

The second conductor 328 may contact the interior of the anode cavity through a contact well 313 formed inwards from a surface of the substrate 340. This contact well 313 may extend into the same side of the substrate 340 as the cathode well 320. Once the well is formed, the conductor 328 may be placed within the well, and an insulator layer 317 may be placed over the conductor 328 to reveal only a contact pad (not shown). Similarly, an insulator layer 317 may be placed over the conductor 326 to reveal only a contact pad (not shown).

The anode cavity 318 provides an access path for fuel (or a reaction medium containing the fuel) to the ion exchange layer 324 (or in the case of a hydrogen fuel cell, to an anode layer). A second flow path is inherently provided for passage of an oxidant (such as from the ambient air) to the cathode 322.

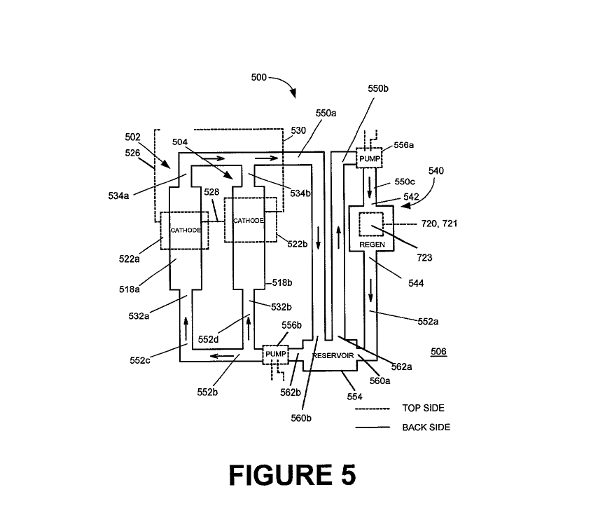

Referring to FIG. 5, a second embodiment of the invention comprises an electrochemical power system 500. The system 500 in turn comprises one or more fuel cells 502, 504, a regeneration unit 540 servicing the fuel cells 502, 504, and a reservoir 554 for the storage of fuel regenerated by the regeneration unit 540. The fuel cells 502, 504, the regeneration unit 540, and the reservoir 554 can each be integrated on or into a substrate 506. For purposes of illustration only, two fuel cells 502, 504 are shown coupled in series in the system 500 of FIG. 5, and one regeneration unit 540 is shown servicing the two fuel cells 502, 504. However, it should be appreciated that embodiments of system 500 are possible employing one or more than two fuel cells, coupled in series or parallel, or connected to different loads altogether. Moreover, embodiments are possible which employ more than one regeneration unit or which do not employ a reservoir, at least one which is separated from the regeneration unit. Accordingly, this particular example should not be taken as limiting.

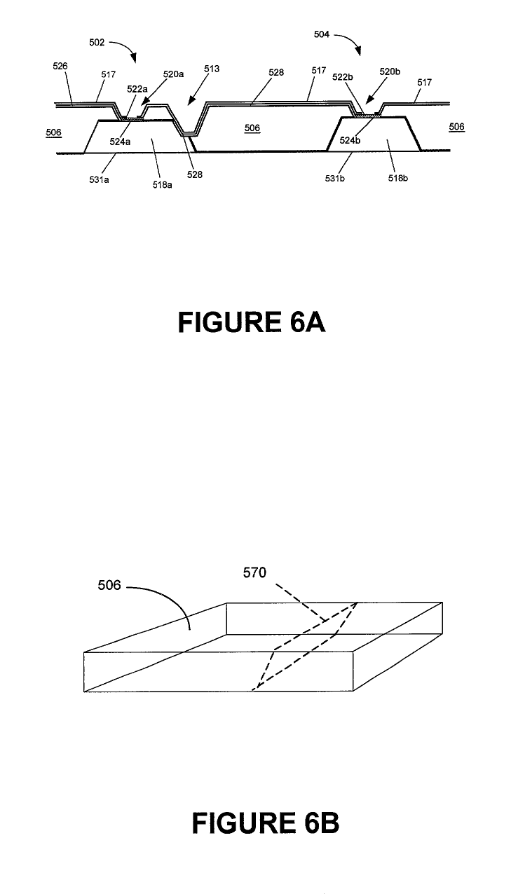

Referring to FIG. 6A, a side view of the fuel cell portion of the system 500 is shown. As shown, each fuel cell 502, 504 comprises an anode cavity 518a, 518b integrated on or into the substrate 506 which is capable of holding a fuel. In operation, this fuel may form at least a portion of the anode of the respective fuel cell. Referring to FIG. 5, each cavity 518a, 518b has one or more regions of ingress 532a, 532b and one or more regions of egress 534a, 534b for the fuel. Referring back to FIG. 6A, an optional cathode well 520a, 520b extends into a first surface of the substrate 506 and is in general proximity to the anode cavity 518a, 518b. A cathode 522a, 522b is situated in the cathode well 520a, 520b, and an ion exchange layer 524a, 524b forms at least a portion of interior of the cavity 518a, 518b and separates the cathode 522a, 524b from the anode cavity 518a, 518b. Again, the ion exchange layer 524a, 524b substantially conducts ions but does not substantially conduct electrons. In one example, each fuel cell 502, 504 comprises a metal fuel cell, and the ion exchange layer 524a, 524b comprises a porous membrane composed of a polymer such as polypropylene. In another example, each fuel cell 502, 504 comprises a hydrogen fuel cell in which the ion exchange layer 524a, 524b comprises a proton exchange membrane composed of a cation exchange polymer. A first conductor, identified with numeral 526 for fuel cell 502 and numeral 528 for fuel cell 504, connects to the cathode 522a, 522b, and a second conductor, identified with numeral 528 for fuel cell 502, connects to the interior of the anode cavity 518a and to the cathode 520b. A second conductor (not shown in FIGS. 6A or 6B) also connects to the interior of anode cavity 518b (or to an anode in the case of a hydrogen fuel cell). The conductors may connect to integrated load or control circuitry optionally included on the same substrate.

The second conductor 528 may contact the interior of the anode cavity 518a (or an anode) through a contact well 513 formed in the substrate 506. (Similarly, a second conductor 530 (shown in FIG. 5 but not FIG. 6) may contact the interior of the anode cavity 518b (or an anode) through a contact well (not shown) formed in the substrate 506.). This contact well 513 may extend into the same side of the substrate 506 as the optional cathode well 520a, 520b. Once the well 513 is formed, the conductor 528 may be placed within the well, and an insulator layer 517 may be placed over the conductor 328. Similarly, an insulator layer 517 may be placed over the conductor 526 to reveal only a contact pad (not shown). An insulator layer 517 may further be placed over the second conductor 530 connected to the interior of anode cavity 518b.

In the case in which the substrate 506 is a planar substrate, the ion exchange layers 524a, 524b in this embodiment may be at least partly perpendicular to the plane of the substrate. Referring to FIG. 6B, a plane 570 is illustrated which is at least partly perpendicular to the plane of substrate 506. This plane 570 represents a permissible orientation of the ion exchange layers 524a, 524b in this embodiment.

The anode cavities 518a, 518b provide an access path for the fuel (or a reaction medium containing the fuel) to the ion exchange layers 524a, 524b (or, in the case of a hydrogen fuel cell, to anode layers). A second access path is inherently provided for the passage of an oxidant (such as from ambient air) to the cathode 522a, 522b.

Referring back to FIG. 5, the system also comprises a regeneration unit 540 integrated on or into the substrate 506. This regeneration unit 540 comprises a reaction chamber 723 and one or more regions of ingress 542 and one or more regions of egress 544 for one or more reaction products. The chamber 723 may also have one or more regions of egress (not shown) for a second reactant, typically an oxidant.

One or more flow paths 550a, 550b, 550c, 552a, 552b, 552c, 552d integrated on or into the substrate 506 interconnect the anode cavity 518a, 518b of the one or more fuel cells 502, 504 with the reaction chamber 723 through the regions of ingress 532a, 532b, 542 and egress 534a, 534b, 544 thereto. Typically, a first flow path 550a, 550b, 550c interconnects the one or more regions of egress 534a, 534b of the anode cavity 518a, 518b with the or more regions of ingress 542 of the reaction chamber 723, and a second flow path 552a, 552b, 552c, 552d interconnects the one or more regions of egress 544 of the reaction chamber 723 with the one or more regions of ingress 532a, 532b of the anode cavity 518a, 518b. One or more reservoirs 554 for the storage of fuel and/or reaction products and/or a second reactant may be situated along one or more of the flow paths. The one or more reservoirs 554 may be coupled to the rest of the system 500 through suitable couplers. In one example, the couplers are microfluidic couplers or the like as produced through MEMs techniques.

One or more circulating means 556a, 556b may also be situated along the one or more flow paths for impelling the fuel and/or reaction products to move along the respective flow paths. If a first flow path interconnects the one or regions of egress of the anode cavity to the one or more regions of ingress of the reaction chamber, and a second flow path interconnects the one or more regions of egress of the reaction chamber to the one or more regions of ingress of the anode cavity, a first circulating means 556a may be situated along the first flow path, and a second circulating means 556b may be situated along the second flow path. Each circulating means may be embodied as a pump, an impeller, a device for causing circulation of the fuel and/or reaction products through convection as described in U.S. Pat. No. 5,006,424, incorporated herein by reference, a device for causing circulation of the fuel and/or reaction products through gradient(s) in any force (e.g., gravity, electromagnetic force(s), and the like) and/or system operating condition (e.g., temperature, pressure, and the like), and the like, and suitable combinations of any two or more thereof. Each of the circulating means may be implemented through MEMs technology, as described in U.S. Pat. Nos. 5,972,187 and 5,890,745, both of which are hereby fully incorporated by reference herein as though set forth in full. In one example, the circulating means is a peristaltic pump such as produced through MEMs techniques.

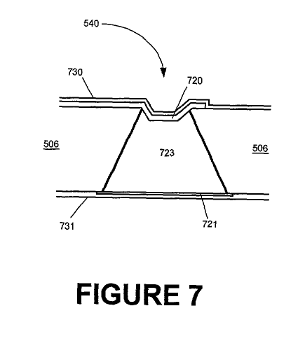

Referring to FIG. 7, additional detail about the regeneration unit 540 is illustrated. As illustrated, reaction chamber 723 is integrated within substrate 506. In addition, a conductor 720 connects to the interior of the reaction chamber 723 and forms the anode of the regeneration unit 540. (As shown, the anode 720 may be patterned onto an optional contact well). The reaction chamber 723 may be capped by a cap 531, at least a portion of which, identified with number 721, comprises a conductor which connects to the interior of the reaction chamber 723, and forms the cathode of the regeneration unit 540. The anode 720 may be covered by an insulator layer 730 that leaves exposed only a contact pad (not shown). Similarly, the cap 731 embedding cathode 721 may be composed of an insulating material and configured to leave exposed only a contact pad (not shown) for cathode 721.

Referring back to FIG. 5, a voltage, which may be derived from an external power source, may be applied across the anode 720 and cathode 721 to power the regeneration unit 540. When power is so applied, any fuel that is formed (as dendrites or in some other form) may be circulated back as fuel into the anode cavities of the fuel cells of the system.

Optionally, a suitable screen, or some other structure that permits the break up of undesirable forms of such formed fuel (e.g., dendrites and the like) while permitting the circulation of desirable forms of such formed fuel (e.g., fuel particles and the like) in a fluid, can be incorporated across a relevant flow path.

This external power source may also be used to power the one or more circulating means 556a, 556b. The conductors 526 and 530 extending from the fuel cells 502, 504 may form the leads for providing power to one or more external loads (not shown). Alternatively, they may be connected to control or load circuitry optionally integrated on the same substrate.

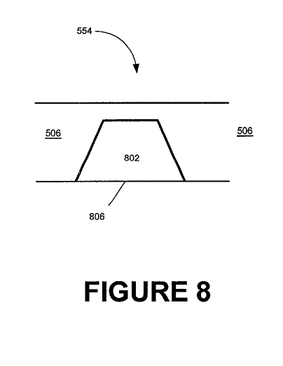

Referring to FIG. 8, an embodiment of reservoir 554 in the system 500 of FIG. 5 is illustrated. This reservoir, which may be used for the storage of fuel and/or reaction products and/or a second reactant, is integrated on or into the substrate 506. A cavity 802 extends inwards from a surface of the substrate 506, and is capped by a cap 806 which may be the same or a different material than substrate 506. Referring to FIG. 5, the reservoir may have one or more regions of ingress 560a, 560b, and one or more regions of egress 562a, 562b.

A third embodiment of the invention comprises a metal fuel cell integrated on or into a substrate where the fuel cell has a like structure and configuration as the fuel cells 502, 504 described above in relation to the system 500 illustrated in FIG. 5, but with the additional requirement that the portions of the interior of the anode cavity, and the regions of ingress and egress thereto, which come in contact with the reaction medium employed in the metal fuel cell, be substantially chemically inert with respect to the reaction medium. These areas may be inherently substantially chemically inert, or may be rendered substantially chemically inert through various means, such as layering these areas with a layer of a substantially chemically inert substance, or by suitable doping of these areas. Such substances or dopants generally depend on the reaction medium used, but, in the case of a potassium hydroxide solution, a suitable chemically inert substance for coating is PTFE.

A fourth embodiment of the invention comprises a fuel cell or electrochemical power system integrated on or into a substrate in which features such as cavities or wells are formed through additive processes such as injection molding. In one example, the substrate is a non-conductive polymer formed through injection molding.

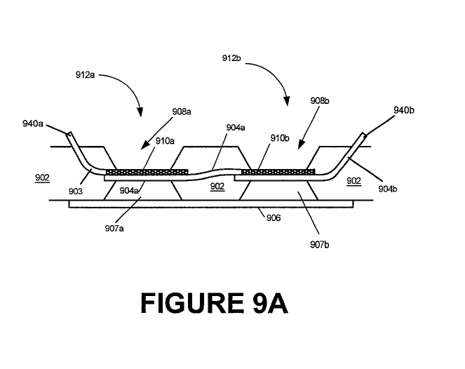

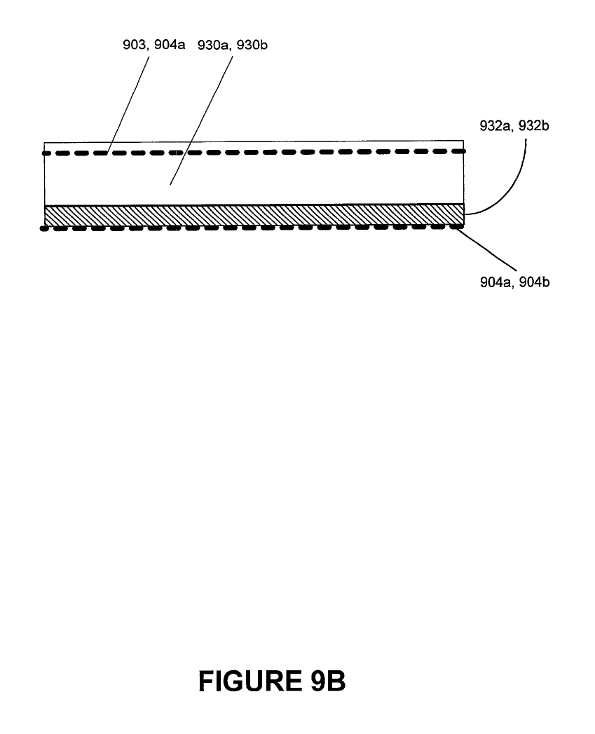

Referring to FIG. 9, a side view of the fuel cell portion of an example of an electrochemical power system which is in accordance with this fourth embodiment is illustrated. In this example, two fuel cells 912a and 912b are coupled in series and integrated on or into substrate 902, but it should be appreciated that examples are possible where more or less than two fuel cells are included, or where the fuel cells are coupled in parallel or where the fuel cells are coupled to independent loads. Therefore, this example should not be taken as limiting.

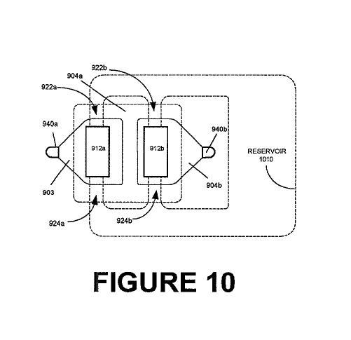

As illustrated, an anode cavity 907a, 907b for each fuel cell 912a, 912b is integrated on or into the substrate 902. These cavities may each be capped by a cap 906 which may be the same or a different material than that making up the substrate 902. The cavities 907a, 907b each have one or more regions of ingress and egress thereto (not shown in FIG. 9). Referring to FIG. 10, which is a plan view of the electrochemical power system of which the fuel cell portion illustrated in FIG. 9 is a part, the one or more regions of egress for fuel cell 912a are identified with numeral 922a, and the one or more regions of egress for fuel cell 912b are identified with numeral 922b. Similarly, the one or more regions of ingress for fuel cell 912a are identified with numeral 924a, and the one or more regions of ingress for fuel cell 912b are identified with numeral 924b.

Referring back to FIG. 9, optional cathode wells 908a, 908b extend inwards from a surface of substrate 902, and allow passage of a second reactant, such as oxygen from the ambient air, to electrode elements 910a, 910b. A conductor 904b is situated within well 908b and connects to and forms at least a portion of the interior of anode cavity 907b. The electrode element 910b is also situated within well 908b and adjacent to conductor 904b. A conductor 904a extending from electrode element 910b is situated within well 908a and connects to and forms at least a portion of the interior of anode cavity 907a. The electrode element 910a is also situated within well 908a and adjacent to conductor 904a. A conductor 903 extends from electrode element 910a.

Together, the electrode elements 910a, 910b, and the conductors 903, 904a, 904b comprise an electrode assembly having first and second conducting leads, where the first lead comprises conductor 903, and the second lead comprises conductor 904b.

In one example, the conductor 904a may be an extension of a metal mesh current collector attached to electrode element 910b, and conductor 903 may be an extension of a metal mesh current collector attached to electrode element 910a. In this example, the electrode elements 910a, 910b and related conductors 903, 904a, 904b may be configured as illustrated in FIG. 9B. In particular, electrode element 910a, 910b may comprise a cathode layer, identified respectively with numerals 930a, 930b. As illustrated, metal mesh current collector 903 may be integrated on or into cathode 930a, and metal mesh current collector 904a may be integrated on or into cathode 930b. In one implementation, cathode layer 930a, 930b and integrated current collector 903, 904a comprises a three-layer structure, where the first layer comprises a catalyst layer formed of a suitable catalyst such as but not limited to platinum integrated on or into a suitable pore-forming material such as carbon. The second layer, which is placed over the first, comprises the current collector 903, 904a. The third layer, placed over the second, comprises a porous backing layer which, in one example, comprises a hydrophobic material such as but not limited to a hydrophobic polymer.

Cathode 930a is adjacent to ion exchange layer 932a, and cathode 930b is adjacent to ion exchange layer 932b. Ion exchange layer 932a in turn is adjacent to metal mesh current collector 904a (extending from cathode 930b), and ion exchange layer 932b is adjacent to conductor 904b, which may also be configured as a metal mesh even though it is not integrated on or into a cathode. Additional detail regarding electrode elements such as this may be found in U.S. Patent Application Nos. To Be Determined, Howrey Dkt. Nos. 04813.0022.NPUS00, Howrey Dkt. No. 04813.0013.NPUS00, and Howrey Dkt. No. 04813.0025.NPUS00, filed, respectively, on Oct. 9, 2001, Oct. 19, 2001, and Oct. 19, 2001. Each of these patent applications is hereby fully incorporated by reference herein as though set forth in full.

In an alternative embodiment, applicable in the case of hydrogen fuel cells, an anode layer can be placed below the ion exchange layer. In one implementation, the anode may be coupled to metal mesh current collector extending from another electrode assembly.

The anode cavities 907a, 907b provide an access path for a fuel (or a reaction medium containing a fuel) to the ion exchange layers in the electrode assemblies 910a, 910b. (The conductors 904a, 904b are either assumed to be sufficiently porous to allow passage of the fuel or reaction medium containing the fuel to the ion exchange layers, or only extend into the anode cavities 907a, 907b to the extent necessary to contact the fuel rather than extending across the entire lower surface of the ion exchange layers.). In the case of a hydrogen fuel cell, where anode layers are placed below the ion exchange layers, the anode cavities 907a, 907b provide an access path for the fuel or reaction medium containing the fuel to the anode layers. An access path for an oxidant (such as from the ambient air) to the cathode layers is provided in this arrangement by cathode wells 908a, 908b.

Referring to FIG. 10, additional details about the foregoing electrochemical power system are illustrated. One end of conductor 904b connects to the surface of substrate 902 and forms a pad 940b that may be used for connecting the system to an external load (or control or load circuitry optionally integrated on the same substrate). Similarly, one end of conductor 903 connects to the surface of substrate 902 and forms a pad 904a that may be used for connecting the system to an external load (or control or load circuitry optionally integrated on the same substrate).

A reservoir 1010 is situated below the fuel cells 912a, 912b. The reservoir 1010 is configured to store fuel regenerated from a regeneration unit (not shown) and to store one or more reaction products from the fuel cells 912a, 912b for regeneration into fuel by the regeneration unit. A first manifold (not shown) provides a path for the fuel from reservoir 1010 to the regions of ingress 924a, 924b of the anode cavities 907a, 907b. Similarly, a second manifold (not shown) provides a path for the one or more reaction products from the regions of egress 922a, 922b of the fuel cells 912a, 912b to the reservoir 1010. One or more circulating means (not shown) may also be provided to facilitate the flow of fuel from the reservoir 1010 to the fuel cells 912a, 912b and the flow of reaction products from the fuel cells 912a, 912b to the reservoir 1010. Moreover, through the placement of reservoir 1010 below fuel cells 912a, 912b, the force of gravity can also facilitate the flow of reaction products from the fuel cells 912a, 912b to the reservoir 1010.

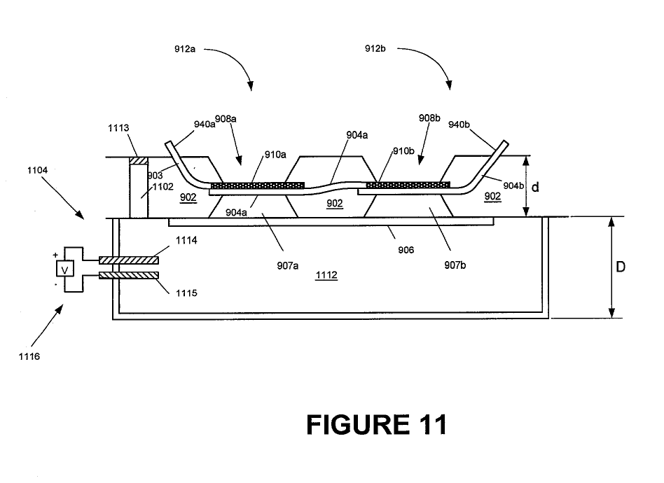

Referring to FIG. 11, a side view of a second example of an electrochemical power system integrated on or into a substrate formed through additive processes is illustrated. In this example, the fuel cell portion of the system is identical to that illustrated in FIG. 9A and employed in the system of FIG. 10, and need not be explained further.

In this example, a regeneration unit 1104 is placed below the fuel cell portion of the system. Moreover, the vertical dimension D of the regeneration unit 1104 can be larger than the vertical dimension d of the substrate 902 since the regeneration unit 1104 in this embodiment is not integrated on or into the substrate but instead is external and adjacent to it.

Moreover, a hole 1102 is formed through the substrate 902 and extends into the reaction chamber 1112 of the regeneration unit 1104. The hole is capped by a porous window 1113. Together, the hole 1102 and window 1113 function as a point of egress for a second reactant from the interior of the reaction chamber 1112 of the regeneration unit 1104.

The electrodes 1114 and 1115 respectively form the anode and cathode of the regeneration unit 1116. When reaction products from fuel cells 912a and 912b are introduced into the interior of the chamber 1112, and a voltage is applied across the electrodes 1114 and 1116, fuel will form on the surface of negative electrode 1115. In one implementation, the fuel is in the form of dendrites that may be swept off electrode 1115 through mechanical means, such as scraping or vibration, or may be swept off through fluid means, such as a flow of reaction medium. However removed, this fuel may be reintroduced back into the anode cavities 907a, 907b of the fuel cells 912a, 912b through pumping means, which, in one example, is a peristaltic pump formed through MEMS techniques.

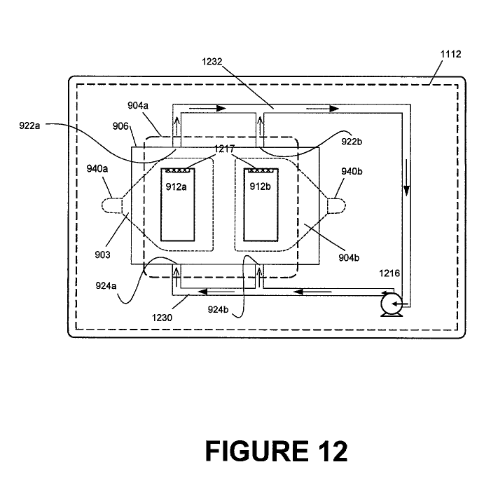

Referring to FIG. 12, a plan view of the example shown in FIG. 11 is illustrated. End portion 940b of conductor 904b contacts the surface of substrate 902 and forms a contact pad for connecting to an external load (or control or load circuitry which can be integrated on or into the same substrate). Similarly, end portion 940a of conductor 904a contacts the surface of substrate 902 and forms a contact pad also for connecting to an external load (or control or load circuitry which can be integrated on or into the same substrate). Manifold 1230 carries fuel from regeneration unit 1104 to the anode cavities of the fuel cells 912a and 912b through the regions of ingress, identified with numerals 924a and 924b respectively. Similarly, manifold 1232 carries one or more reaction products from the regions of egress of the anode cavities of the fuel cells 912a and 912b, identified with numerals 922a and 922b respectively.

One or more pumps 1216 pump fuel from reaction chamber 1112 into the anode cavities of fuel cells 912a, 912b through manifold 1230, and pump one or more reaction products from the anode cavities of the fuel cells 912a, 912b back to the chamber 1112 through manifold 1232. The pumps used to pump fuel to the fuel cell from the regeneration unit may be the same or different from the pumps used to pump regenerated fuel from the regeneration unit back to the fuel cells. Since the process of fuel regeneration does not typically occur while the fuel cells are discharging, these pumps may be the same.

Screens 1217 may be situated with the anode cavities of the fuel cells 912a, 912b if needed to stop particulate fuel from exiting the cavities along with the reaction products.

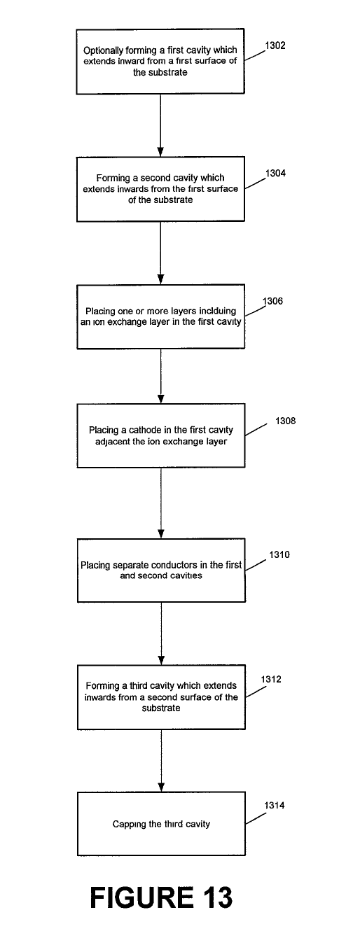

Referring to FIG. 13, an embodiment of a method of integrating a fuel cell on or into a substrate is illustrated. In one example, subtractive processes such as patterned etching may be employed to embed the fuel cell in the substrate. In optional step 1302, the method comprises forming a first cavity that extends inwards from a first surface of the substrate. In one example, the substrate comprises a semiconductor wafer, the first cavity comprises a cathode well, and step 1302 comprises etching the cathode well into the upper surface of the semiconductor substrate using a photo-resist mask and a suitable etchant. The cathode well in this example can range from about 1 to about 120 microns in depth, and, in alternative embodiments, ranges from about 50 to about 70 microns in depth.

From step 1302, the method proceeds to step 1304, which comprises forming a second cavity that extends inwards from the first surface of the substrate. In one example, the substrate is a semiconductor wafer, the second cavity is a contact well, and step 1304 comprises etching the contact well into the upper surface of the semiconductor substrate using a photo-resist mask and a suitable etchant (such as KOH). The contact well in this example can range from about 1 to about 120 microns in depth, and, in alternative embodiments, ranges from about 110 to about 130 microns in depth.

The method proceeds to step 1306, which comprises placing one or more layers comprising an ion exchange layer in the first cavity. As discussed previously, the ion exchange layer should be such as to substantially conduct ions but not substantially conduct electrons. In one example, in which the fuel cell to be integrated is a metal fuel cell, step 1306 comprises depositing a layer of a hydrophilic polymer such as polypropylene which functions as the ion exchange layer. In a second example, in which the fuel cell to be integrated is a hydrogen fuel cell, the ion exchange layer comprises a proton exchange layer, and step 1306 may comprise depositing an anode layer followed by a layer of a cation exchange polymer such as nafion which functions as the proton exchange layer. In either of these examples, the one or more layers can be deposited through standard semiconductor deposition procedures, and then etched away using a sacrificial mask in all areas except the bottom of the cathode well. The one or more layers in either of these examples may each be in the range of about 1 to about 30 microns and preferably ranges from about 10 to about 20 microns.

From step 1306, the method proceeds to step 1308, which comprises placing a cathode in the first cavity adjacent to the ion exchange layer. The cathode may comprise a single layer or multiple layers. The cathode may also comprise a catalyst for the reducing reaction which occurs thereat. In one example, the cathode comprises a two-layer structure in which the first layer is a catalyst layer and the second layer is a porous backing layer. In one configuration, the cathode structure should be such as to provide mechanical integrity, electrical conductivity, provide oxidant (e.g., oxygen, and the like) permeability to the catalyst thereof, and allow for adequate oxidant (e.g., oxygen, and the like) diffusion towards the anode.

In one example, in which the fuel cell to be integrated may be a metal or hydrogen fuel cell, the cathode comprises a two-layer structure, in which the first layer comprises a mixture of a catalyst such as but not limited to platinum and a conductive pore-forming agent such as but not limited to carbon which is deposited through a suitable deposition process such as, but not limited to, sputtering, CVD, or evaporation. The second layer in this structure comprises a hydrophobic backing layer configured to prevent flooding of the cathode. This second layer is also deposited through a suitable deposition process such as, but not limited to, sputtering, CVD, or evaporation. This two-layer structure, one deposited, may then be etched away using a sacrificial mask and suitable etching agent so that the two-layer structure only remains on the bottom of the contact well.

From step 1308, the method proceeds to step 1310, which comprises placing separate conductors in the first and second cavities. In one example, the second cavity is a contact well, and this step comprises depositing a metal layer such as nickel over the contact well and cathode well, and then patterning it so that separate conductors extend from the bottoms of both wells.

Through this step, a metal conductor composed of a metal such as nickel may be connected to the catalyst layer in this example, and sandwiched between the catalyst and backing layers. After the catalyst layer is deposited, the metal conductor may be deposited and patterned. The backing layer may then be deposited over the metal conductor and catalyst layer. An insulator layer may then be deposited over the backing layer, and patterned to allow adequate diffusion of a second reactant (such as oxygen) towards the bottom of the cathode well. In one implementation, this layer insulates or protects the underlying layer or layers.

Step 1310 is followed by step 1312, which comprises forming a third cavity that extends inwards from a second surface of the substrate. The third cavity can be formed so that it is configured to have one or more regions of ingress, and one or more regions of egress thereto.

In one example, the substrate is a semiconductor wafer, the third cavity is an anode cavity, and step 1312 comprises etching the anode cavity into the bottom surface of the semiconductor wafer at an area that opposes the cathode and contact wells extending inwards from the upper surface of the wafer. hi this example, the etching is performed until an ion exchange layer at the bottom of the cathode well connects with and forms at least a portion of the interior of the anode cavity, and the conductor placed in the bottom of the contact well also connects with and forms at least a portion of the interior of the anode cavity.

In the case of a hydrogen fuel cell where an anode layer has not been previously deposited, step 312 may comprise depositing and patterning an anode layer on the underside of the ion exchange layer.

Step 1312 is followed by step 1314, in which the third cavity is capped. In one example, the third cavity is capped by a cap or lid which is adhered to or otherwise affixed to the bottom of the third cavity, and which may be the same or different material from the substrate.

In an optional next step, applicable in the case in which the fuel cell is a metal fuel cell, and a reaction solution is employed to carry fuel into the anode cavities of the fuel cells, and to carry one or more reaction products out of the anode cavities, the portions of the interior of the anode cavity, and the regions of ingress and egress thereto, which come in contact with the reaction solution, may be rendered substantially chemically inert in relation to the reaction solution, such as by coating these areas with a suitable material or by suitable doping of these areas. This step may involve masking the underside of the ion exchange layer before coating, or otherwise implanting, doping, or altering, the reaction medium contacting areas to render them chemically inert.

In one example, the reaction solution is KOH, and these areas are either coated with a layer of PTFE to render them substantially chemically inert with respect to KOH. Suitable doping is also a possible mechanism for rendering the areas of contact with the reaction medium substantially chemically inert thereto.

The anode cavities should be formed such that one or more regions of ingress and egress thereto are included. Moreover, if the resultant integrated fuel cells are to be part of an electrochemical power system, a regeneration unit, optionally one or more reservoirs, one or more circulating means and suitable flow channels linking these elements with the anode cavities, an optionally control or load circuitry should also be formed or included in the substrate through additive or subtractive processes, or suitable combinations of the two. One of ordinary skill in the art will be able to perform these tasks after reading this disclosure.

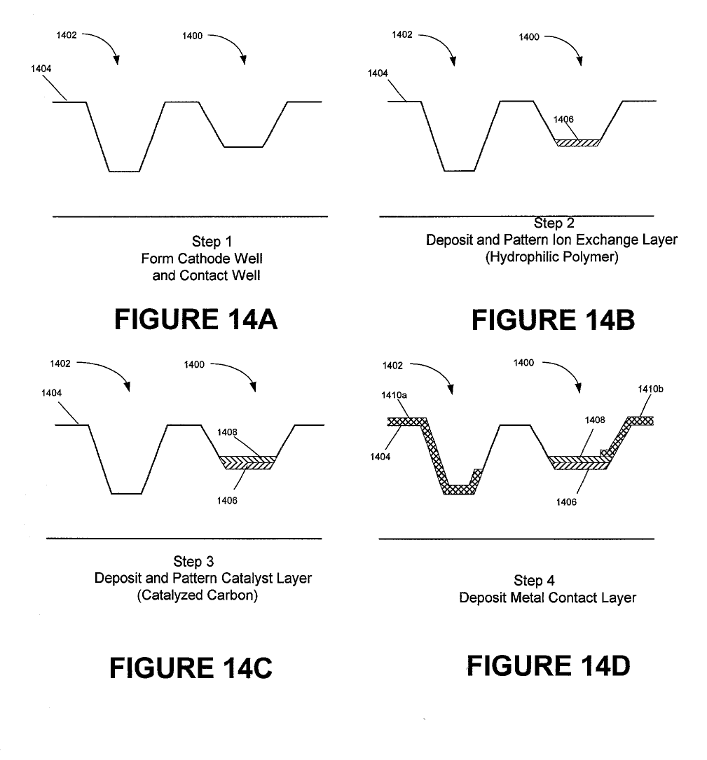

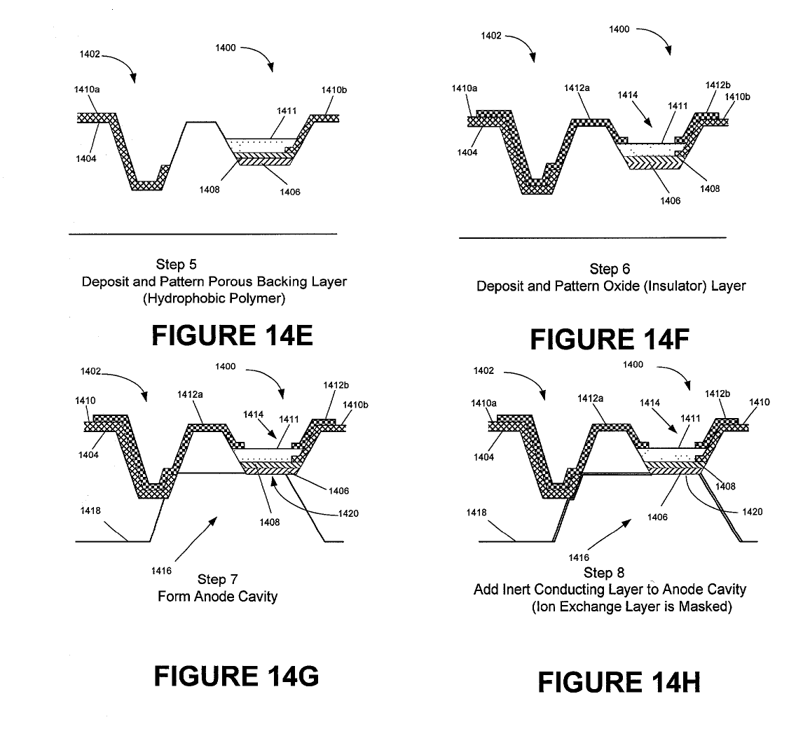

Referring to FIGS. 14A-14I, a first example of the method of FIG. 13 is illustrated. In the first step, illustrated in FIG. 14A, cathode well 1400 and contact well 1402 are etched into the upper surface 1404 of a semiconductor wafer. Many other examples are possible, so this example should not be taken as limiting.

In the second step, illustrated in FIG. 14B, the ion exchange layer 1406 (which in one example is a hydrophilic polymer) is deposited and patterned so it is confined to the bottom of the cathode well 1400.

In the third step, illustrated in FIG. 14C, catalyst layer 1408 (which in one example is catalyzed carbon) is deposited over ion exchange layer 1406 and patterned so that it is again confined to the bottom of the cathode well 1400.

In the fourth step, illustrated in FIG. 14D, a metal conducting layer is deposited and patterned to form separate conductors 1410a and 1410b, where conductor 1410a forms a bridge to contact well 1402, and conductor 1410b contacts cathode layer 1408.

In step five, illustrated in FIG. 14E, porous backing layer 1411 (which is one example comprises a hydrophobic polymer) is deposited over the metal and ion exchange layers and patterned as shown.

In the sixth step, illustrated in FIG. 14F, one or more insulator layers 1412a, 1412b may be deposited over the porous backing and metal conducting layers and patterned as shown so that an opening 1414 is present which allows diffusion of a second reactant (such as oxygen from the ambient air or from some other source) towards the bottom of the cathode well.

The seventh step is illustrated in FIG. 14G. There, anode well 1416 is etched into the bottom surface 1418 of the semiconductor wafer. The anode cavity 1416 is situated at a location that generally opposes that of contact well 1402, and cathode well 1400. It extends into the interior of the substrate sufficiently so that the metal conductor 1418 at the bottom of the well connects with and forms at least a portion of the interior of anode well 1416, and so that the ion exchange layer 1406 at the bottom of the cathode well 1400 connects with and forms at least a portion of the interior of anode well 1416.

In one example, applicable in the case in which the fuel cell to be integrated is a hydrogen fuel cell, an anode is deposited on the upper surface 1420 of the anode cavity such that it contacts and is adjacent to ion exchange layer 1406. The anode may comprise a single layer or multiple layers. The anode may also comprise a catalyst for the oxidizing reaction which occurs thereat. In one example, the anode comprises a two-layer structure in which the first layer is a catalyst layer and the second layer is a porous backing layer. In one configuration, the anode structure should be such as to provide mechanical integrity, electrical conductivity, provide hydrogen permeability to the catalyst thereof, and/or allow for adequate hydrogen diffusion towards the cathode.

In one example, the anode comprises a two-layer structure, in which the first layer comprises a mixture of a catalyst such as but not limited to platinum and a conductive pore-forming agent such as carbon that is deposited through a suitable deposition process such as, but not limited to, sputtering, CVD, or evaporation. The second layer in this structure comprises a hydrophobic backing layer configured to prevent flooding of the anode. This second layer is also deposited through a suitable deposition process such as sputtering, CVD, or evaporation. This two-layer structure, one deposited, may then be etched away using a sacrificial mask and suitable etchant so that the two-layer structure only remains on the top of the anode cavity in the general vicinity of the ion exchange layer of the cathode.

The eighth optional step is illustrated in FIG. 14H. There, in the case in which the fuel cell is a metal fuel cell and a reaction solution is employed, the interior portions of the anode cavity which come in contact with the reaction solution, and the regions of ingress and egress thereto, are rendered substantially chemically inert in relation to the reaction solution, if not already so.

In the ninth step, illustrated in FIG. 14I, the anode cavity 1416 is capped with a lid or cap 1422 which may also comprise a semiconductor material.

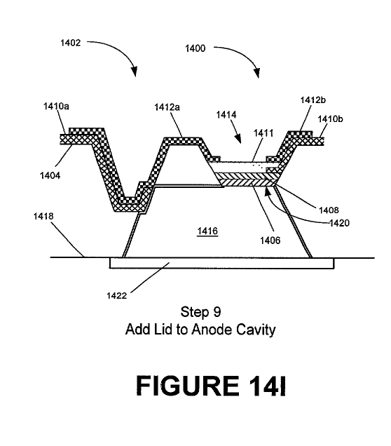

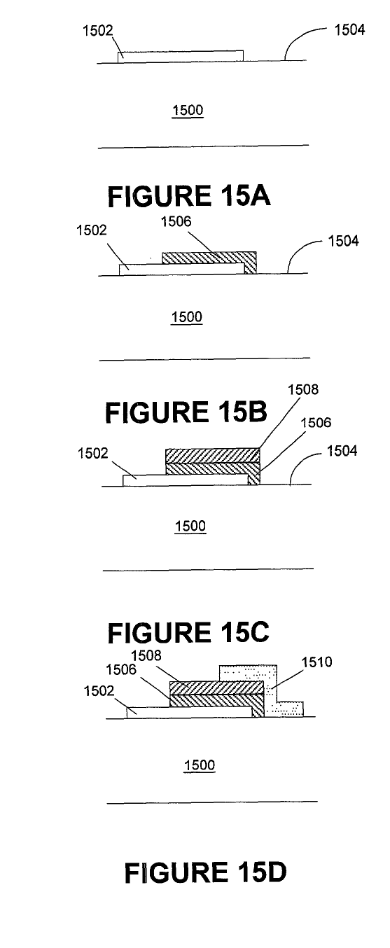

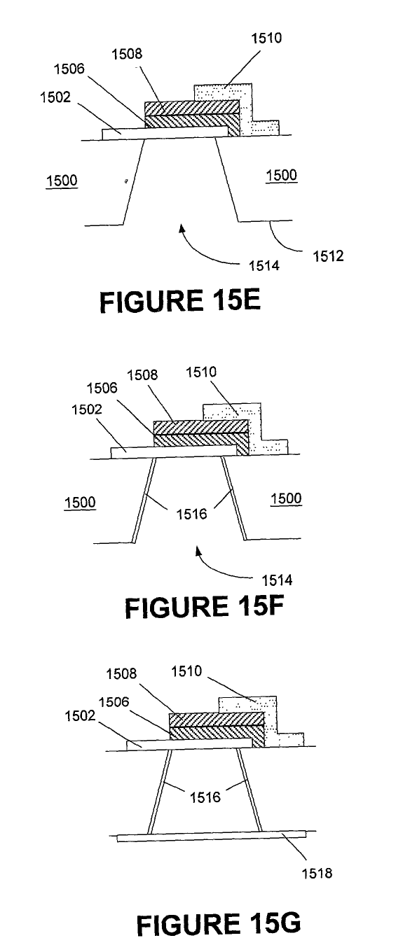

Referring to FIGS. 15A-15G, a second example of integrating a fuel cell on or into a substrate according to the method of FIG. 13 is illustrated. In the first step, illustrated in FIG. 15A, a porous conductor layer 1502 is deposited and patterned on a first surface 1504 of substrate 1500.

In the second step, illustrated in FIG. 15B, an ion exchange layer 1506 is deposited and patterned on top of the porous conductor layer 1502 as shown.

In the third step, illustrated in FIG. 15C, a catalyzed cathode layer 1508 is deposited and patterned on top of the ion exchange layer 1506 as shown.

In the fourth step, illustrated in FIG. 15D, a second conductor layer 1510 is deposited and patterned on top of the catalyzed cathode layer 1508 as shown.

In the fifth step, illustrated in FIG. 15E, an anode cavity 1514, which extends inwards from surface 1512 of the substrate, is formed as shown. In particular, the cavity 1514 extends inwards sufficiently such that the porous conductor layer 1502 contacts and forms at least part of the interior of the cavity 1514.

In the sixth step, illustrated in FIG. 15F, employed when a metal fuel cell is involved, the interior of the anode cavity 1514 is coated with an inert layer 1516 at areas of contact with the reaction medium which is used. (The underside of the porous conductor 1502 may be masked during this coating step.).

In the seventh step, illustrated in FIG. 15G, the anode cavity 1514 is capped with lid 1518 which may be the same material as substrate 1500. The anode cavity 1514, after capping, still has one or more areas of ingress thereto, and one or more area of egress thereto.

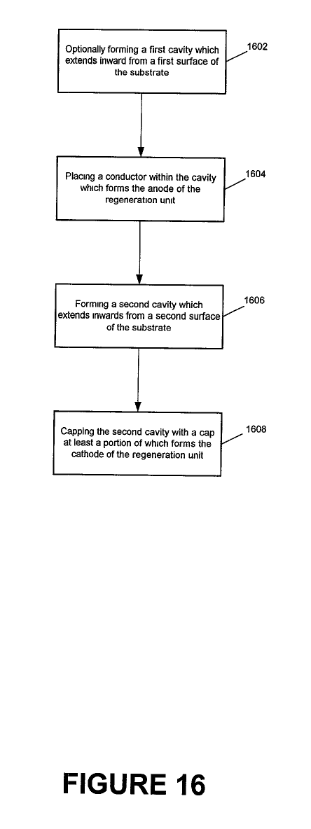

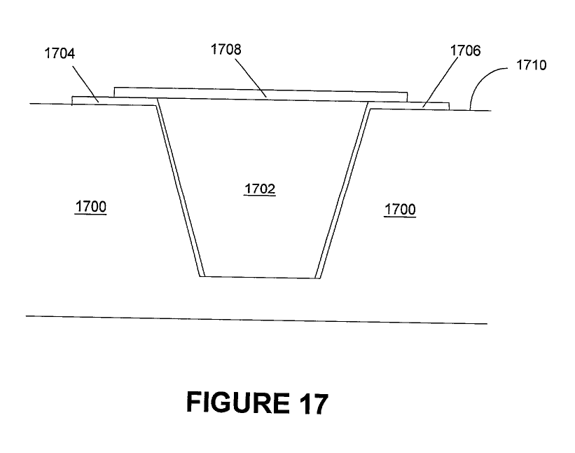

Referring to FIG. 16, a flowchart of one embodiment of a method of integrating a regeneration unit on or into a substrate is illustrated. In one example, the method employs a subtractive process such as patterned etching to embed the regeneration unit.

In this embodiment, the method begins with optional step 1602, which comprises forming a first cavity that extends inwards from a first surface of a substrate. This step may occur through a subtractive process such as etching or patterned etching. In one example, the first cavity is a contact well etched into one side of a semiconductor wafer substrate using a photo-resist mask and a suitable etching material.

Step 1602 is followed by step 1604, which comprises placing a conductor in the cavity. This conductor will form the anode of the regeneration unit. In one example, this step comprises depositing a metal layer, and then patterning the metal layer so that the resulting conductor is confined to extending from the bottom of the contact well to one side thereof.

Side 1604 is followed by step 1606, which comprises forming a second cavity in a second surface of the substrate. Again, this second cavity may be formed through a subtractive process such as etching. In one example, the second cavity comprises a reaction chamber for the regeneration unit that is etched into the second side of the semiconductor wafer substrate in a location generally opposing the contact well. The reaction chamber is etched sufficiently into the side of the wafer such that the conductor at the bottom of the contact well connects with the interior of the reaction chamber, and forms at least a portion of the interior thereof.

Step 1606 is followed by step 1608, which comprises capping the second cavity with a cap, at least a portion of which forms the cathode of the regeneration unit. In one example, the cap is a two-layer structure where the first layer comprises a conductor and the second layer comprises the same material as the substrate. The cap may be oriented such that the interior of the cap (which faces into the reaction chamber) comprises the conductor layer. This conductor layer then becomes the cathode of the regeneration unit.

In one implementation, where the substrate is a silicon wafer, the cap comprises a metal layer deposited over at least a portion of the surface of a silicon layer. The cap is affixed to the substrate in such a way as to cover the reaction chamber, and so that the metal layer is oriented into the interior of the reaction chamber.

Optionally, the conductor forming the anode is covered with an insulating material, and extended so that it forms a contact pad on the first surface of the substrate. In addition, the conductor forming the cathode may be connected so that it forms a contact pad on the second surface of the substrate. An external power source may then be coupled to the regeneration unit through these two pads.

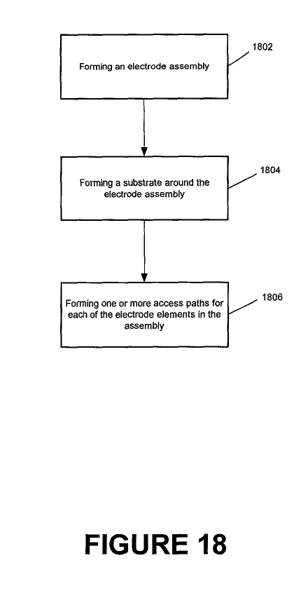

Referring to FIG. 18, an embodiment of a regeneration unit that may be formed through application of the foregoing process is illustrated. As shown, a cavity 1702 is etched into the surface 1710 of substrate 1700. A first conductor 1704 is deposited and patterned on one side of cavity 1702, and a second conductor 1706 is deposited and patterned on the other side of cavity 1702. A cap or lid 1708 is then placed over the top of the cavity as shown. The cavity, after capping, still has one or more areas of ingress thereto, and one or more areas of egress thereto.

Referring to FIG. 18, a second embodiment of a method of integrating a fuel cell on or into a substrate is illustrated. In this embodiment, the fuel cell may be integrated on or into the substrate through an additive process such as injection molding.

This embodiment begins with step 1802, which comprises forming an electrode assembly. The electrode assembly comprises one or more electrode elements coupled in series or in parallel or coupled to independent loads, with first and second conductors forming the leads of the electrode assembly.

In one example, the electrode assembly comprises a plurality of electrode elements coupled in series, whereby the ion exchange layer of one electrode element is placed adjacent to and above a conductor formed by extending the metal mesh current collector of an adjacent electrode element. A first conductor formed by extending the metal mesh current collector of one of the end electrode elements in the assembly forms one of the leads of the electrode assembly. A second metal mesh conductor placed adjacent to and below the ion exchange layer in the other end electrode element in the assembly forms the other lead of the electrode assembly.

In the case where the fuel cells comprise hydrogen fuel cells, a suitable anode layer may be placed adjacent to and below the ion exchange layers of each of the electrode elements in the assembly. In one example, the anode layer in an electrode element may be coupled to a conductor extending from another electrode element in the assembly.

From step 1802, the method proceeds to step 1804, which comprises forming a substrate around the electrode assembly. This forming step may be performed through an additive process. In one example, this step comprises placing the electrode assembly in a mold, and then forming the substrate through injection molding, i.e., by injecting a moldable material such as but not limited to molten polymer into the mold, such that the first and second leads of the electrode assembly connect with an outer surface of the resultant substrate. This step may also comprise forming the substrate such that an access path for an oxidant to the cathode layer in each of the electrode elements is formed, and a second access path for a fuel or reaction medium containing the fuel is formed to one of the layers in each of the electrode assemblies (anode layer in the case of a hydrogen fuel cell, ion exchange layer in the case of a metal fuel cell). Alternatively, the formation of these access paths may be performed through subtractive processes invoked after the substrate is formed through an additive process.

From step 1804, the method proceeds to step 1806, which comprises forming one or more access paths for each of the electrode elements in the assembly. As discussed, this step may be performed as part of step 1802, and may be performed separately, such as through a subtractive process. The mode in which this step is performed as part of step 1804 has already been discussed, so here, the focus is on performing this step separately.

In one example, a first access path is formed for each of the electrode elements, for allowing passage of a suitable oxidant to the cathode layer in the respective assembly, and a second access path is formed for each of the electrode assemblies, for allowing passage of a fuel or reaction medium containing the fuel to a layer in the layer stack (anode layer in the case of a hydrogen fuel cell, and ion exchange layer in the case of a metal fuel cell).

In one implementation, the second access path comprises an anode cavity formed for each of the electrode elements, where the anode cavity for an element is placed below the element, and configured such that the conductor in the element extending from an adjacent element connects with and forms at least a portion of the interior of the anode cavity.

The anode cavities should be formed such that one or more regions of ingress and egress thereto are included. Moreover, if the resultant integrated fuel cells are to be part of an electrochemical power system, a regeneration unit, optionally one or more reservoirs, one or more circulating means and suitable flow channels linking these elements with the anode cavities should also be formed or included in the substrate through additive processes, subtractive processes, or suitable combinations of any two or more thereof. One of ordinary skill in the art will readily recognize additional ways to perform these tasks after reading this disclosure.

The fuel cell, electrochemical power system, or any component thereof (e.g., regeneration unit, reservoir) of any of the foregoing embodiments may be integrated onto an integrated circuit substrate, i.e. a substrate on which circuitry of some kind is also integrated.

The integrated circuitry may be fabricated on a silicon wafer in whole or in part prior to the fabrication of the fuel cell. The front end of the process, where the functionality of the integrated circuit is produced (transistor, resistor, capacitor, etc.) involves many high temperature processes. During this processing, the thermal budget should be carefully considered as all high temperature cycles (>˜900 C.) will promote redistribution of dopants through diffusion, thus altering the function. The back end of the process comprises the metallization of the circuit, protective coatings and finally bonding leads. These processes are much lower in temperature. For example, after metallization, the circuit can be alloyed at 450 C. for 15-30 minutes to minimize the contact resistance. Another example is during bonding where the die can be heated to 320-370 C. while a heated gold wire is brought into contact with the pad.

The integration of the fuel cell (system) with the integrated circuit fabrication requires addressing the thermal budget throughout the entire process. For this reason, the front end of the integrated circuit should be fabricated first. The backend of the integrated circuit may be partially completed before the fuel cell is fabricated. However, some of the steps may also be accomplished in parallel with the fabrication of the fuel cell. In order to protect the integrated circuitry, it should be isolated by means of an oxide or nitride mask during the fabrication of the fuel cell. It is important to note that the temperatures for the back end of the integrated circuit fabrication are on the order of the temperature that are required to fabricate the ion exchange membrane and cathode for the fuel cell. Through careful analysis, these two processes can be made compatible and interwoven to produce the entire system including fuel cell, regeneration, reservoir, and integrated circuitry.

In WO 01/54217, placement of an individual hydrogen fuel cell cavity on an integrated circuit chip is discussed, but this reference does not address placing an electrochemical power system employing a fuel cell on a chip or placing a metal fuel cell on an IC chip, both of which pose particular challenges not addressed through placement of a hydrogen fuel cell cavity on an IC chip. Moreover, in this fuel cell, the proton exchange membrane thereof is perpendicular to the plane of the integrated circuit chip, and thus has limited or sub-optimal effectiveness.

In WO 00/45457, placement of a hydrogen fuel cell on a segmented silicon substrate is discussed, and mention is made of using this fuel cell with an external fuel reservoir as part of a package approach or in the form of a modular cartridge. However, this reference does not address integration of an electrochemical power system on a substrate, or integration of a fuel cell or system employing the same on a unitary substrate.

Similarly, German Patent No. 19914681; WO 00045457; JP 7-201348; Electrochemical and Solid-State Letters, Vol. 3, No. 9, September 2000, pp. 407-409, Kelley, et al., address placing individual fuel cell cavities on IC chips, but none address placing electrochemical systems employing fuel cells on IC chips.

While various embodiments of the invention have been described, it will be apparent to those of ordinary skill in the art that many more embodiments and implementations are possible that are within the scope of this invention.

What is claimed is:

1. A fuel cell integrated on or into a unitary planar substrate having first and second sides comprising:
at least two stacked layers comprising a cathode layer and an ion exchange layer situated on or within the substrate, the ion exchange layer being oriented substantially within the plane of the substrate;
a first access path for allowing an oxidant to access the cathode layer from the first side of the substrate;
a second access path for allowing a fuel or a reaction medium containing a fuel to access a layer in the stack from the second side of the substrate;
a first conductor connecting to the cathode; and
a second conductor connecting to the second access path or the layer in the stack accessible through the second access path.

2. The fuel cell of claim 1 wherein the substrate comprises a semiconductor substrate.

3. The fuel cell of claim 1 wherein the substrate comprises an injection molded substrate.

4. The fuel cell of claim 1 wherein the fuel cell comprises a metal fuel cell.

5. The system of claim 1 wherein the fuel cell comprises a hydrogen fuel cell.

6. The fuel cell of claim 5 wherein the layer in the stack accessible through the second access path comprises an anode layer.

7. The system of claim 4 wherein the layer in the stack accessible through the second access path comprises an ion exchange layer.

8. The system of claim 2 wherein the substrate comprises an integrated circuit substrate.

9. An electrochemical power system employing one or more fuel cells integrated on or into a substrate having first and second sides comprising:
one or more fuel cells integrated on or into the substrate, each such fuel cell comprising:
at least two stacked layers comprising a cathode layer and an ion exchange layer situated on or within the substrate;
a first access path for allowing an oxidant to access the cathode layer from the first side of the substrate;
a second access path for allowing a fuel or a reaction medium containing a fuel to access a layer in the stack from the second side of the substrate;
a third access path, which may be the same or different from the second access path, for allowing egress of one or more reaction products from the layer;
a first conductor connecting to the cathode; and
a second conductor connecting to the second access path or the layer in the stack accessible through the second access path;
a regeneration unit, integrated on or into the substrate comprising:
a reaction chamber integrated on or into the substrate which is capable of holding one or more reaction products, the chamber having an interior and one or more regions of ingress and one or more regions of egress;
an anode connecting to the interior of the reaction chamber; and
a cathode connecting to the interior of the reaction chamber;
a first flow path interconnecting the one or more third access paths of the one or more fuel cells with the one or more regions of ingress of the reaction chamber; and
a second flow path interconnecting the one or more regions of egress of the reaction chamber with the one or more second access paths of the one or more fuel cells.

10. The system of claim 9 comprising two or more integrated fuel cells coupled in series.

11. The system of claim 9 comprising two or more integrated fuel cells coupled in parallel.

12. The system of claim 9 wherein the substrate comprises a semiconductor substrate.

13. The system of claim 9 wherein the substrate comprises an injection molded substrate.

14. The system of claim 9 further comprising one or more reservoirs for storing one or more reaction products and situated along the first flow path between the one or more third access paths of the one or more fuel cells and the one or more regions of ingress of the reaction chamber.

15. The system of claim 9 further comprising one or more reservoirs for storing regenerated fuel and situated along the second flow path between the one or more regions of egress of the reaction chamber and the one or more second access paths of the one or more fuel cells.

16. The system of claim 9 further comprising one or more circulating means situated along the first flow path for impelling the one or more reaction products to flow along the first flow path.

17. The system of claim 9 further comprising one more circulating means situated along the second flow path for impelling the regenerated fuel to flow along the second flow path.

18. The system of claim 9 wherein the reaction chamber has one or more regions of egress for a second reactant.

19. The system of claim 9 wherein the one or more fuel cells comprise hydrogen fuel cells.

20. The system of claim 9 wherein the one or more fuel cells comprise metal fuel cells.

21. The system of claim 19 wherein the layer in each fuel cell accessible by the second access path comprises an anode layer.

22. The system of claim 20 wherein the layer in each fuel cell accessible by the second access path comprises the ion exchange layer.

23. A metal fuel cell integrated on or into a substrate having first and second sides comprising:
at least two stacked layers comprising a cathode layer and an ion exchange layer situated on or within the substrate;
a first access path for allowing an oxidant to access the cathode layer from one side of the substrate;
a second access path for allowing a reaction medium containing a metal fuel to access the ion exchange layer in the stack from the other side of the substrate;
a first conductor connecting to the cathode; and
a second conductor connecting to the second access path.

24. The metal fuel cell of claim 23 wherein the fuel comprises zinc.

25. The metal fuel cell of claim 23 wherein the reaction medium comprises potassium hydroxide solution.

26. The metal fuel cell of claim 24 wherein the zinc fuel comprises zinc particles.

27. The metal fuel cell of claim 23 wherein the second access path has an interior that is substantially chemically inert with respect to the reaction medium at the areas of contact therewith.

28. The metal fuel cell of claim 27 wherein the interior of the second access path is substantially chemically inert with respect to the reaction medium at the areas of contact therewith through suitable coating.

29. The metal fuel cell of claim 27 wherein the interior of the second access path is substantially chemically inert with respect to the reaction medium at the areas of contact therewith through suitable doping.

30. The metal fuel cell of claim 23 wherein the substrate comprises a semiconductor substrate.

31. The metal fuel cell of claim 23 wherein the substrate comprises an injection molded substrate.

32. The metal fuel cell of claim 23 wherein the second access path comprises a cavity in the substrate.

33. A method of integrating a fuel cell on or into a substrate comprising:
placing at least two stacked layers comprising a cathode layer and an ion exchange layer on a surface of a substrate;
forming an access path to one of the layers which extends inward from an opposing surface of the substrate;
connecting a first conductor to the cathode layer; and
connecting a second conductor to the access path or the layer which is made accessible by the access path.

34. The method of claim 33 wherein the forming step comprises an etching step.

35. The method of claim 34 wherein the etching step comprises a patterned etching step.

36. The method of claim 33 wherein the substrate is a planar substrate having first and second sides, and the surface is on the first side of the substrate, and the opposing surface is on the second side of the substrate.

37. The method of claim 33 wherein the fuel cell comprises a metal fuel cell.

38. The method of claim 37 wherein the layer accessible by the access path comprises the ion exchange layer.

39. The method of claim 33 wherein the fuel cell comprises a hydrogen fuel cell.

40. The method of claim 39 wherein the layer accessible by the access path is an anode layer.

41. The method of claim 33 wherein the surface of the substrate on which the stacked layers are placed is within a cavity.

42. A method of integrating a regeneration unit on or into a substrate comprising:
forming a cavity which extends inward from a surface of the substrate, the cavity having an interior and one or more regions of ingress and egress thereto;
connecting a first electrode to the interior of the cavity; and
connecting a second electrode to the interior of the cavity.

43. The method of claim 43 wherein the forming step comprises an etching step.

44. The method of claim 43 wherein the etching step comprises a patterned etching step.

45. The method of claim 42 further comprising capping the cavity with a cap.

46. The method of claim 45 wherein the second electrode is integrated on or into the cap.

47. A method of integrating a fuel cell on or into a substrate comprising:
forming an electrode assembly comprising one or more electrode elements, wherein each of the electrode elements in the assembly comprises at least two stacked layers comprising a cathode layer and an ion exchange layer; and
forming a substrate around the electrode assembly, with first and second conductors connecting a surface of the substrate to the electrode assembly, a first access path for an oxidant to the cathode layer in each of the electrode assemblies, and a second opposing access path for fuel or a reaction medium containing a fuel to one of the layers in the stack.

48. The method of claim 47 wherein the substrate forming step comprises an injection molding step.

49. The method of claim 47 wherein one of the layers in an electrode element is a conductor extending from another electrode element in the assembly.

50. The method of claim 47 wherein the one or more fuel cells comprise metal fuel cells.

51. The method of claim 50 wherein the layer in an electrode element accessible through the second access path comprises the ion exchange layer.

52. The method of claim 50 wherein the one or more fuel cells comprise hydrogen fuel cells.

53. The method of claim 52 wherein the layer in an electrode element accessible through the second access path comprises an anode layer.

54. The method of claim 53 wherein the anode layer in an electrode element is coupled to a conductor extending from another electrode element.

55. The system of claim 9 wherein the first flow path is integrated on or into the substrate.

56. The system of claim 9 wherein the second flow path is integrated on or into the substrate.

57. The metal fuel cell of claim 23 wherein the substrate comprises a unitary planar substrate.

58. A method of integrating a fuel cell on or into a substrate comprising:
a step for placing at least two stacked layers comprising a cathode layer and an ion exchange layer on a surface of a substrate;
a step for forming an access path to one of the layers which extends inward from an opposing surface of the substrate;
a step for connecting a first conductor to the cathode layer; and
a step for connecting a second conductor to the access path or the layer which is made accessible by the access path.
